(19) United States
(12) Patent Application Publication
(10) Pub. No.: US 2005/0198636 A1
(43) Pub. Date: Sep. 8, 2005

(54) Dynamic optimization of batch processing

(75) Inventors: Eric Lawrence Barsness, Pine Island, MN (US); Randy William Ruhlow, Rochester, MN (US); John Matthew Santosuosso, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/787,722

(22) Filed: Feb. 26, 2004

(51) Int. Cl. G06F 9/46

(52) U.S. Cl. 718/100

(57) ABSTRACT

Methods, systems, and computer program products for dynamically adjusting computer resources, as appropriate, in response to predictions of batch runtimes as well as for rendering costs of the computer resources actually utilized, which costs are consistent with customer demands.

### CROSS REFERENCE TO RELATED APPLICATIONS

The present invention is related to the following copending and commonly assigned U.S. patent applications: ROC 920030051US1 and ROC 920030052US1; commonly filed herewith and incorporated herein by reference and made a part hereof.

### BACKGROUND OF THE INVENTION

The present invention relates generally to computer-implemented data processing methods, systems, and computer program products. More particularly, it relates to dynamically optimizing use of computer resources, as appropriate, so that batch runtimes complete at or reasonably close to predefined set time frames or batch windows.

Customers generally demand to have batch job runtimes complete within predefined batch windows, for example, overnight and before the next business day. Typically, a known amount of processing capacity is used for batch processing. However in present situations, the processors may not complete the job within the batch window, or the processors may complete the job much faster or slower than expected even within the batch window. Clearly, these kinds of variations can cause undesirable disruptions to customers businesses. Moreover, in the emerging area of on-demand it would be highly advantageous to avoid particular batch runtimes completing well inside the batch window. Alternatively, in the emerging area of on-demand it would be highly advantageous to avoid the processing time exceeding the batch window runtime. Unfortunately, meeting such customer demands is problematic. While there are known batch job sizing tools that permit customers to predict the amounts of resources needed to complete batch jobs, such sizing tools do not dynamically predict for execution times for batch jobs. Accordingly, there is no known approach for dynamically predicting batch runtimes. Moreover, there is no known approach for dynamically allocating and/or de-allocating resources in response to the dynamic predictions so that a batch run completes at or reasonably close to predefined batch windows. Moreover, such tools do not apportion allocated resource costs with actual resource usage.

Accordingly, there are needs in the computer industry for methods, systems, and computer program products for dynamically adjusting processing capacity, as appropriate, in response to predictions of batch runtimes as well as for rendering costs of the computer resources actually utilized, which costs are consistent with customer demands. In addition, there are needs for dynamically alerting customers or system users regarding non-completion of a batch job within a specified batch window.

### SUMMARY OF THE INVENTION

The present invention provides enhanced methods, systems, and computer program products for dynamically optimizing computer resources for batch processing, or the processing of programs not requiring interaction, preferably in a coupled environment, without negative effect and that overcome many of the disadvantages of prior art processing arrangements.

The present invention provides improvements in methods, systems, and computer program products for a scheduling manager for dynamically predicting the amount of computer resources needed to complete the execution of a program, preferably a batch program, at or in close proximity to a predefined servicing period.

The present invention provides improvements in methods, systems, and computer program products for dynamically allocating and/or de-allocating processing resources based on dynamic predictions in order to insure the noted completion of a batch runtime generally at or reasonably close to a predefined batch window.

The present invention provides improvements in methods, systems, and computer program products wherein the dynamic predictions are performed at discrete time segments during batch processing based on monitoring of a batch job.

The present invention provides improvements in methods, systems, and computer program products wherein the predictive determinations are based on monitoring the progress of those portions of the batch job already executed at the discrete time segments.

Aspects of the present invention include improvements in methods, systems, and computer program products wherein the predictive determinations are based on monitoring the progress of executed portions of the batch program.

Aspects of the present invention include improvements methods, systems, and computer program products wherein the dynamically allocated computer resources are appropriately allocated and/or de-allocated to meet time and cost constraints demanded by the system user.

Aspects of the present invention provide improvements in methods, systems, and computer program products for allowing customers even greater selectivity in determining the occurrence of batch processing, as well as the duration of batch processing, and any attendant costs associated with customer priorities.

Aspects of the present invention include improvements in methods, systems, and computer program products wherein the customer is charged only for the processing resources utilized.

Aspects of the present invention include improvements in methods, systems, and computer program products wherein if a batch runtime completes before the end of a batch window, customers are not overcharged for unused processing.

Aspects of the present invention include improvements in methods, systems, and computer program products wherein if the processing time for the batch window is exceeded, customers are not charged additionally for computing resources beyond that which was agreed upon.

Aspects of the present invention include improvements in methods, systems, and computer program products wherein the system user is provided with an indication that the batch processing will not be completed generally within the predefined batch window, thereby allowing the system user to obtain alternative solutions.

Aspects of the present invention include improvements in methods, systems, and computer program products wherein the predictive determinations are performed dynamically based on user specified parameters.

Aspects of the present invention include improvements in methods, systems, and computer program products wherein the predictive determinations are based, in part, on the computer resources available.

Still another aspect of the present invention is that it provides for fee based processing of batch jobs in a reliable and efficient manner for resources that are actually utilized.

These and other features and aspects of the present invention will be more fully understood from the following detailed description of the preferred embodiments, which should be read in light of the accompanying drawings. It should be understood that both the foregoing generalized description and the following detailed description are exemplary, and are not restrictive of the invention.

### BRIEF DESCRIPTION OF THE DRAWINGS

FIG. 1 is a block diagram of an environment having a provider of computing services through a grid environment, in accordance with the present invention.

FIG. 2 is a block diagram of a computer system in accordance with one of the preferred embodiments.

FIG. 3 is a block diagram illustrating logical components in a logically partitioned computer system.

FIGS. 4A-4B represent an exemplary flow diagram illustrating the allocation/de-allocation of resources to a computer system, according to one embodiment of the present invention.

FIG. 5 is an exemplary flow diagram illustrating the allocation of resources responsive to a system user's request, according to one embodiment of the present invention.

FIG. 6 is an exemplary flow diagram illustrating the de-allocation of resources to a system user's request, according to one embodiment of the present invention.

FIG. 7 is an exemplary flow diagram illustrating historical analyses performed by the present invention.

FIGS. 8A and 8B are illustrative of data tables according to the present invention.

FIG. 9 is illustrative of another embodiment of a graphical user interface for allowing a user to specify parameters, which configure operation to meet the demands of customers.

### DETAILED DESCRIPTION

The present invention is generally directed to systems, methods, and computer program products for dynamically optimizing computer resources, as appropriate, for completing batch runtimes generally within a predefined batch window or servicing period. The optimization may involve the allocation/de-allocation of computer resources from among, for example, stand-alone, and/or grid computing, and/or logically partitioned processor environments. In this manner, system users are fairly charged for computer resources utilized, but not charged for unneeded resources.

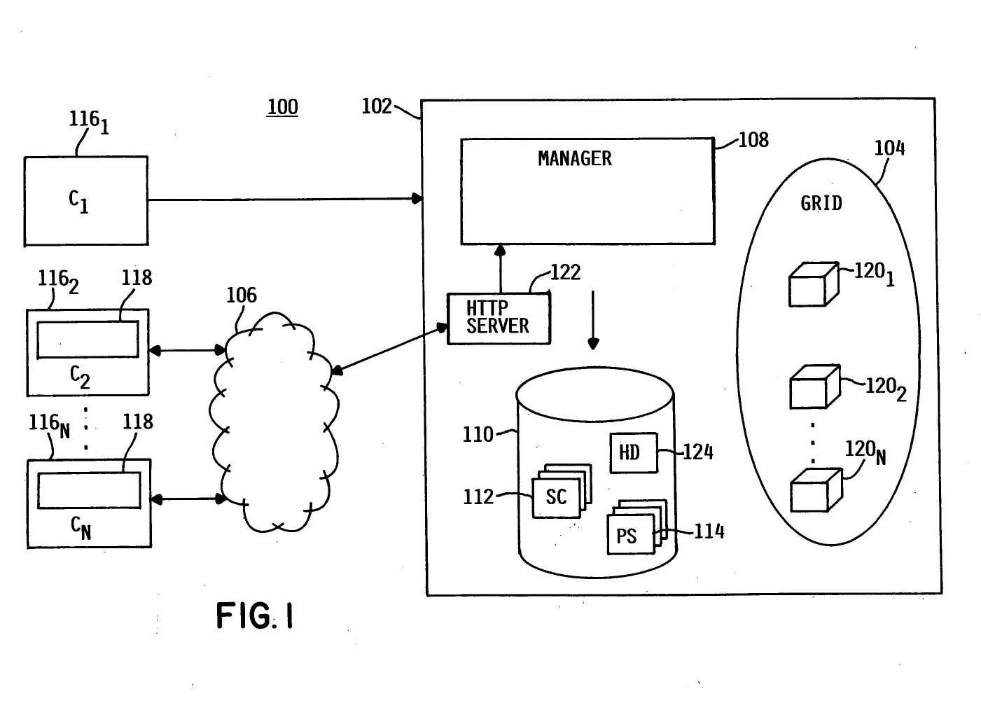

Referring now to FIG. 1, a data processing environment 100 is illustrated in which the present invention is practiced. Generally, the data processing environment 100 includes a provider computer system 102 and a plurality of one or more computer systems 116₁-116_{N} (collectively 116). The provider computer system 102 is illustratively embodied as a server computer with respect to the system users' (client) computer systems 116. Although all computers are illustrated as singular entities, in practice the provider computer system 102 and the client computer systems 116 may all be a network of computers configured to perform various functions, including those described herein. Further, the terms “client” and “server” are utilized merely for convenience and not by way of limitation. As such, the system user computers 116, which may be clients relative to the provider computer system 102 in some regards, may themselves be servers relative to one or more other clients (not shown).

The provider computer system 102 and the computer systems 116 communicate through a network 106. The provider computer system 102 provides access to a grid computing environment 104. Access to various resources within the grid computing environment may also be provided by different service providers. The grid environment 104 may contain a plurality of different computing resources 120₁-120_{N} (collectively 120). The grid-computing environment 104 may include parallel and distributed computing systems that enable sharing, selection, and aggregation of geographically distributed resources at runtime depending on their availability, capability, performance, cost, and/or user's quality of service requirements. The grid computing environment 104 may be a network including diverse hardware and/or software computing resources. These resources may be available and accessible through a network medium such as, the Internet, to a wide variety of users and may be shared between them.

In an exemplary embodiment, the network 106 may be any one of several suitable through which information may be transferred, such as, a local area network (LAN) or a wide area network (WAN). The provider computer system 102 may be configured with a hypertext transfer protocol (HTTP) server 122 for servicing requests from browser programs residing on the computer systems 116. The HTTP server 122 and the browser programs provide convenient and well-known software components for establishing a network connection (e.g., a TCP/IP connection) via the network 106.

Referring back to the provider computer system 102, it may be configured with a manager 108 that requests grid resources for the computer systems 116. In an exemplary embodiment, the manager 108 manages routing requests from the computer systems 116 to the appropriate resources of the grid 104. Such a grid computing system is described in copending and commonly assigned patent application Ser. No. 10/659,976 filed on May 2, 2003, and is incorporated herein and made a part hereof. Some of the requests are fulfilled on a fixed fee basis or a fee basis dependent on a parameter, whereby fees are charged dependant on the time needed to process a batch job request and/or return a response. The manager 108 also monitors progress of the requests by keeping track of time spent on a particular request and calculating a cost. Although, the manager 108 is shown as a single entity, it should be noted that it may be representative of different functions implemented by different software and/or hardware components within the provider computer system 102.

The pricing is determined with respect to any variety of pricing criteria including, for example, time-based criteria, request-type or class criteria, priority criteria, historical information, system user identification criteria, and combinations thereof. These pricing criteria are applied to define pricing schedules that the manager 108 may access to calculate a cost for a request. In one embodiment, pricing criteria is defined in service contracts 112 stored in a database 110. The database 110 may also contain historical data 124 that include a log of requests received and processed in the past, with the corresponding amount of resources utilized and the time taken to process various aspects of the batch jobs. A service contract may exist for each contractual system user of the provider computer system 102 (i.e., each system user with whom the provider computer system 102 has entered into a legal agreement). In another embodiment, pricing criteria may be specified in generic pricing schedules 114 for system users who do not have contractual agreements with the service provider. Different generic pricing schedules 114 may exist for a variety of different pricing criteria including those mentioned above (e.g., request-time criteria, request-type or class criteria, priority criteria, historical information, system user identification criteria, and combinations thereof).

Historical information may also serve as criteria for determining a pricing schedule. Pricing schedules may exist that take account of a combination of the one or more pricing criteria. The historical information may be supplied by the historical data 124 which includes information about the amount of resources and time taken to process a request in the past. The historical data 124 may be searched to determine whether a similar or same request as the request received has been processed in the past. If a similar request is located in the historical data, the information about resources utilized and time taken to process the request may be utilized to select a different pricing schedule. Of course, each of the criteria mentioned above are optional, and may or may not be utilized in determining pricing schedules, in different embodiments.

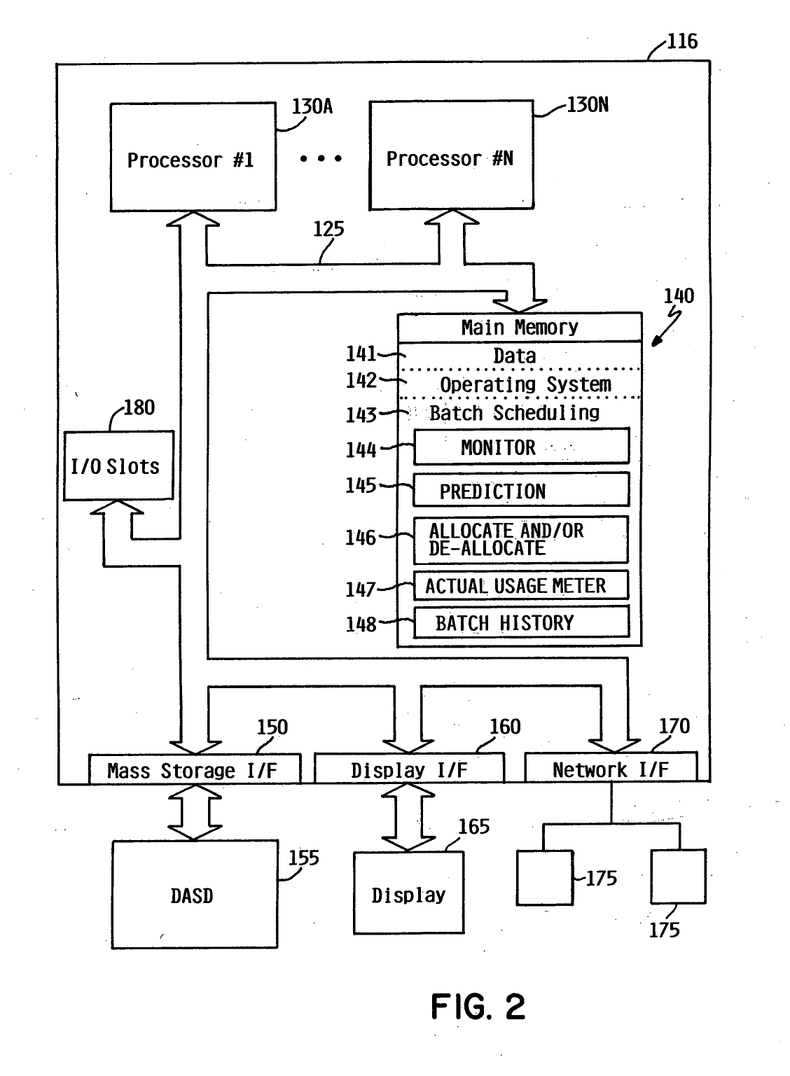

Reference is made to FIG. 2 for illustrating a computer system 116, such as an eServer iSeries computer system commercially available from International Business Machines Corporation, Armonk, N.Y. It will be appreciated that other computer systems are envisioned for use in implementing the present invention and that the illustrated embodiment is exemplary of but one. The computer system 116 comprises one or more processors 130a-n (collectively 130) that are connected to a main memory 140, a mass storage interface 150, a display interface 160, a network interface 170, and a plurality of I/O slots 180. A system bus 125 interconnects these components. Although only a single bus can be utilized, those skilled in the art will appreciate that the present invention can utilize multiple buses. Each one of the processors may be constructed from one or more microprocessors and/or integrated circuits. The processors execute program instructions in the main memory. The mass storage interface 150 is utilized to connect to mass storage devices, such as a direct access storage device (DASD) 155, for example a suitable CD RW drive, to a computer system. The display interface 160 is utilized to directly connect one or more displays 165 to the computer system. The displays 165 which may be non-intelligent terminals or fully programmable workstations. The network interface 170 is utilized to connect other computer systems and/or workstations 175 to computer system 116 across a network. It is pointed out that the present invention applies no matter how many computer systems and/or workstations may be connected to other computer systems and/or workstations, regardless of the network connection technology that is utilized.

The main memory 140 contains data 141 that can be read or written by any processor 130 or any other device that may access the main memory. The main memory can include an operating system 142, and a batch scheduling manager 143. The main memory 140 stores programs and data that the processor may access and execute. The operating system 142 is a multitasking operating system, such as OS/400™, AIX™, or Linux™. Those skilled in the art will appreciate that the spirit and scope of the present invention is not limited to any one operating system. The operating system 142 manages the resources of the computer system including the processor 130, main memory 140, mass storage interface 150, display interface 160, network interface 170, and I/O slots 180. Any suitable operating system can be utilized. The operating system 142 includes applications for operating the system. Included in the memory is the batch scheduling manager 143 which can reside in main memory 140, but, as is known, can reside elsewhere.

The batch scheduling manager 143 manages the type of batch file being processed for appropriately scheduling resources so that batch jobs complete runtimes at or in reasonably close proximity to predefined batch windows. In general, executable files will not be run in a batch mode until a system user describes the job using, for example, a job command language or keyword statements. The job command language describes important aspects of the job to be run. These aspects will be monitored in a manner to be indicated. The present embodiment while directed to batch processing is broader in scope. In this regard, the scheduling manager or mechanism 143 applies to any program or executable that can be characterized as relatively long-running and executes at least substantially without intervention. It can share characteristics similar to batch jobs. Exemplary programs or jobs would be scientific programs that may contain significant data to be processed.

The batch jobs are received by the batch scheduling manager 143. A batch job, for example, could be the running of an application program, such as a monthly payroll program, or the like. A batch job may include a series of job steps, which are sequentially ordered. An example of a job step might be to make sure that a particular data set or database needed in the job is made accessible. Because job steps are sequentially ordered, it is easier to monitor them in order to predict when a batch file will finish. Thus, a user can identify which job steps are to be monitored using the job control language or statements when entering in such values before batch processing commences. However, some batch jobs are not defined by job steps. These other batch jobs are identifiable by the file type or group to which they belong. In this other group, the parameters are usable for monitoring them. These include the total number of processes to be executed. Knowing the amount of total number of processes is information that a system user can enter through a graphical user interface (e.g., GUI), or the like. The job control language also contains information, such as identifying the type or class of batch job that can be monitored as will be described.

The batch scheduling manager 143 operates so that it dynamically optimizes utilization of computer resources whereby the batch runtime finishes at or in close proximity to the predefined batch runtime or servicing period. Accordingly, the costs associated with the particular batch job being run can be more fairly and accurately apportioned. Included in the batch scheduling manager 143 is a monitoring module 144 for monitoring aspects of each batch file for which requests are being made. A predicting module 145 is provided for predicting the amount of resources to be utilized for completing the batch job. A resource allocator/de-allocator module 146 is provided that based on the predictions apportions the computer resources, as appropriate, for completing batch runtimes generally at or in reasonably close proximity to predefined batch windows or servicing periods. An actual computer resources usage metering module 147 is provided for use in determining fees or costs based on actual utilization of computer resources. Accordingly, a fee-based process based on the actual utilization of computer resources for completing a batch job is enabled, whereby costs or fees to be charged to the user are based on actual utilization of computer resources to finish the batch job. A batch history module 148 is provided which creates history tables for new jobs and which updates history tables for known batch jobs.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type or class of computer readable signal bearing media utilized to actually carry out the distribution. The preferred embodiments also extend to a logically partitioned computer system and/or a grid environment.

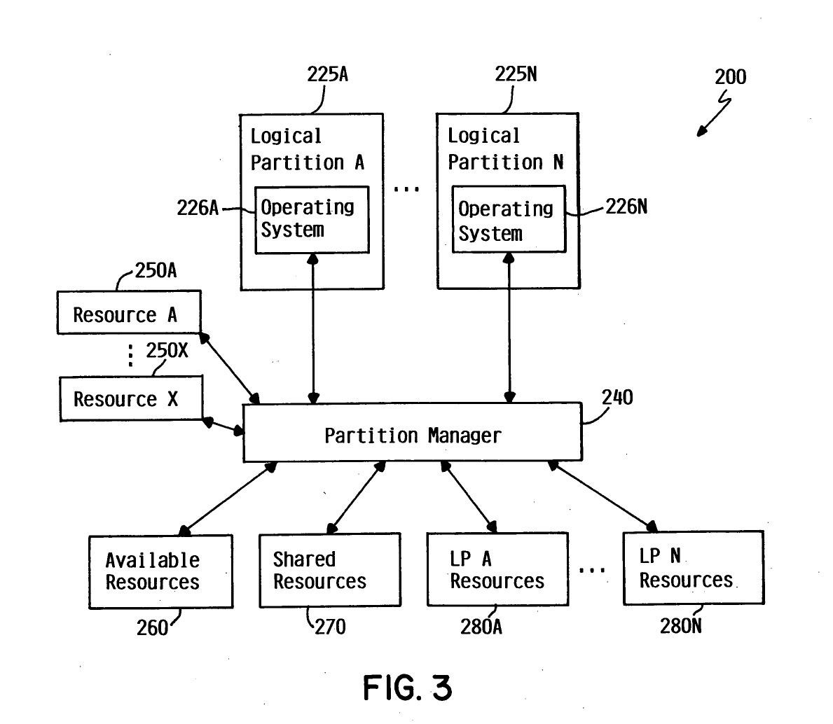

In this regard, reference is made to copending U.S. patent application, Ser. No. 10/616,676 filed Jul. 10, 2003, which is commonly assigned herewith and incorporated herein and made a part hereof. However, only those aspects thereof, which relate to understanding the present invention will be set forth. The logical partitions can provide completely different computing environments on the same physical computer system. Referring to FIG. 3, one specific implementation of a logically partitioned computer system 200 includes N logical partitions, with each logical partition executing its own respective operating system. In FIG. 3, logical partitions 225_{A-N} (collectively 225) are shown executing their respective operating systems 226_{A-N} (collectively 226). The operating system 226 in each logical partition may be the same as the operating system in other partitions, or may be a completely different operating system. Thus, one partition can run the OS/400 operating system, while a different partition can run another instance of OS/400, possibly a different release. The operating systems in the logical partitions could even be different from OS/400, provided it is compatible with the hardware. The logical partitions 225 are managed by a partition manager 240. One example of suitable partition manager 240 is known as a “Hypervisor” that is commercially available from International Business Machine Corporation. The partition manager 240 manages resources 250, shown in FIG. 3 as resource 250. As used in the present application, a “resource” as used in this invention may be any hardware or software or combination thereof that may be controlled by partition manager 240. Examples of hardware resources include processors, memory, and hard disk drives. Examples of software resources include a database, internal communications (such as a logical LAN), or applications (such as word processors, e-mail, etc.). The partition manager 240 controls which resources 250 may be allocated/de-allocated by the logical partitions 225. A resource, once made available to the partition manager 240, is categorized as an available resource 260 if it has not yet been assigned to a logical partition, is categorized as a shared resource 270 if multiple logical partitions may access the resource, and is categorized as a dedicated resource 280_{A-N} (collectively 280) if it has been exclusively assigned to a logical partition.

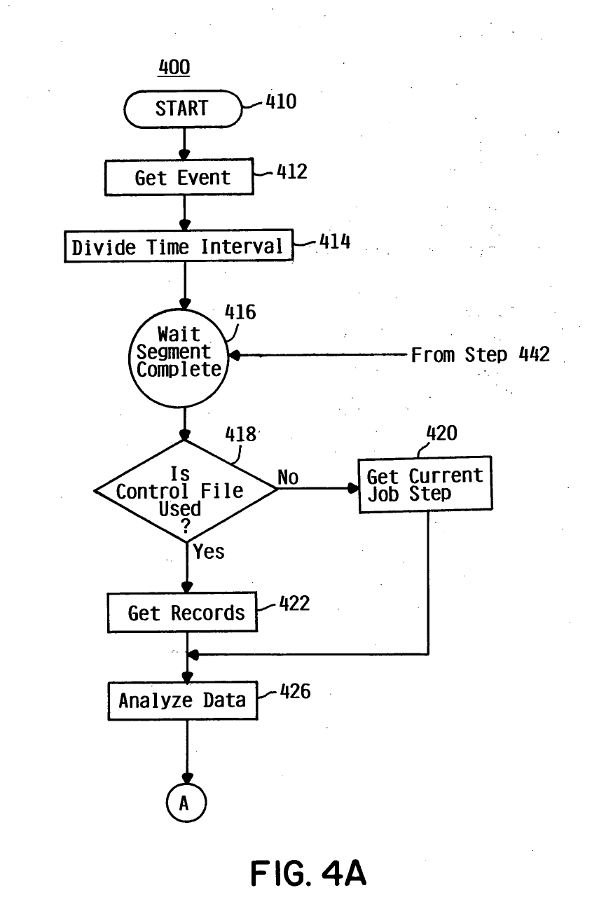

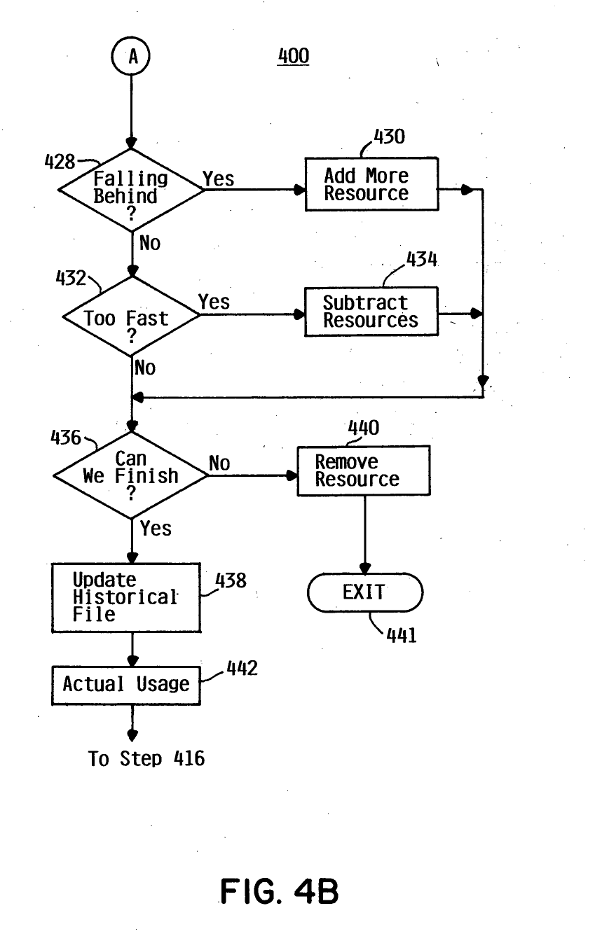

Referring now to FIG. 4, a batch scheduling method 400 is illustrated that is implemented by the data processing system 100 and the batch scheduling manager 143. The batch scheduling method 400 starts in step 410 for dynamically optimizing computer resources appropriately so that batch job(s) can have their batch runtimes complete at or in close proximity to customer specified set time frames or servicing periods. More specifically, the batch scheduling method 400 dynamically predicts batch runtime completion. As a result, it accordingly allocates and/or de-allocates computer resources appropriately. In addition, the batch scheduling method 400 apportions costs for computer resources that are actually utilized. The monitoring module 144 monitors for controlling files of a batch job. Alternatively, the monitoring module 144 monitors job steps of a batch job. As noted, the batch jobs are received by the batch scheduling manager 143. A controlling file is one that is executable in a sequential manner. By being sequential, it is easier to predict when a file will finish within a given time frame. The job control language statements define parameters including the exact or maximum amount of resources that the job requires and the kinds of resources to be applied. The job control language also contains information, such as identifying the type or class of batch job that can be monitored.

In the step 412, a batch job event(s) is received by the batch job scheduler manager 143. The received batch job event(s) may be obtained from one or more batch files on a stand alone system; transmitted from other partitions; transmitted from a grid or other type or class of network, or any combination thereof or other suitable sources.

In step 414, the user specified servicing value entered as a parameter in the GUI might be divided into one or more time intervals. The time intervals may be specified by the user or automatically as a function of the batch job type. Each of the intervals is selected as a measuring unit that will serve as a marker to facilitate a determination of whether a batch job will complete its run in the time defined. Preferably, user selected parameters define these time intervals. For example, the servicing period can be divided into four (4) time segments, such as through a GUI by a system user. Alternatively, the time intervals may be selected automatically based on other criteria, such as historical data for particular types of files. The time intervals need not be equal.

In step 416, the method 400 waits for completion of each of the successive time intervals, specified in step 414. Accordingly, the following steps to be described are implemented before the next time interval occurs in step 414.

In step 418, the batch scheduling manager 143 monitors information from the batch job. The monitored information is used for making a determination as to whether or not controlling job steps or files are being utilized by the batch job. If a controlling job step is used, step 420 is performed. The information about the total job steps can be obtained from the job command language. The current job step information is monitored for use in step 426. As noted, job steps of a control file are arranged in sequence in relationship to time. Therefore, job steps provide relatively reliable information for making predictions regarding a finish time value.

Alternatively if Yes at step 418, then step 422 is performed. In step 422, the batch scheduling manager 143 extracts selected information from a controlling file. For example, the current amount of processing performed during the first time interval is captured or monitored.

In step 426, algorithms are applied by the prediction module 145 on the data input from steps 420 and 422. Essentially, the statistics of executed processes of the controlling file or job steps that were gathered as described above during the first time interval (step 414) are compared to the remaining controlling file or job steps in order to calculate and assign a completion time. Specifically in step 426, analyses are performed by algorithms applied on the information from step 420. The analyses are done to determine, for example, the average time value required to execute each job step. For example, if 100 job steps out of a total of 400 job steps have been executed at the end of the first time interval, then the average time value for executing each of the 100 job steps is computed. This average time value is then applied to the remaining 300 job steps. Accordingly, predictions may be made as to a finish time value. Other statistical tools, besides average job step time, can be utilized to calculate a finish or completion time value for the batch job.

Alternatively in step 426, if the information obtained in step 422 is utilized, then the average amount of processing accomplished in the first time interval is monitored.

As a result, an average value of processing in the first time interval is calculated. In addition, the value for the total amount of processing to be performed within a controlling file is obtained. Specifically, the total processing value may be obtained from the controlling file itself, or from historical statistics regarding similar files stored by the batch history module 148. The historical data may be based on the job log files of similar executed batches. This latter approach is less reliable in terms of predicting the completion of the batch job than when knowing the job steps. As a result, the average processing time value is applied against the predicted value of the total amount of processing files yet to be processed. Accordingly, predictions may be made as to a finish or completion time value for the controlling file.

In step 428, a determination is made as to whether the batch process is falling behind schedule. This occurs after the predicted finish time value of the actual process is compared to the predefined batch runtime value set by the system user. If the actual process is taking longer than demanded by the customer, then a determination is made as to whether processing is falling behind or not. If Yes, then step 430 follows wherein added resources are to be allocated in an amount appropriate. If No, then the process goes to step 432 for de-allocating or subtracting resources appropriately. Similarly, in step 432, a determination is made whether the batch process is too far ahead of schedule. Specifically, the statistical value input from step 426, regarding the average time of completion of the executed to unexecuted portions of the batch job being processed, is compared to the expected average time of completed processing relative to the predefined processing period. As noted, the expected average time value is derived by the expected completed portion of the process as an average time of time of the time interval. If a determination is made that the data from step 426 is at a value above the expected value, then step 434 follows. In step 434, the appropriate amount of computer resources will be subtracted from the process in order for the batch job to finish within the predefined processing period.

In step 436, a determination is made as to whether the process can finish at the completion of the batch window or reasonably close to completion of the batch window. Specifically, an algorithm is applied to determine if the current predicted finish time, as modified by the added or subtracted resources, is at or is within a reasonably close time band at the end of the batch window. This time band can be configured by the system or by the customer. The time band encompasses those situations wherein the process will run to completion before expiration of the originally intended batch window or after expiration of the originally intended batch window. The values of the time band can be based on preselected time values (e.g., minutes) or any other convenient approach can be used for defining the time boundaries.

If the decision at step 436 is No, then step 440 is performed. Specifically in step 440, those resources presently applied to the process, such as from the partition(s) and/or the grid is appropriately removed. Accordingly, step 440 may be responsive to a user specified parameter or even dynamic operation of the process. In step 440, an indication can be transmitted via any suitable transmission facility to the customer that the process will or is to be terminated. The customer can, therefore, act appropriately to handle the situation. Following step 440, the process exits at step 441. Alternatively, if the determination at step 436 is Yes, then step 438 follows. In step 438, appropriate information regarding the process including operating parameters, such as noted in the controlling file table 800 and the step table 810 are inputted. This information regarding the actual running of the batch file is saved for historical purposes and is presently used for billing purposes at step 442. In step 442, the actual utilization of resources during the processing is metered or determined. An algorithm is then applied to take into account not only the actual metered usage of the resources applied during processing, but also any policy pricing values or levels (e.g., pre-payments, premium pricing for faster servicing, etc.) of the customer. Accordingly, the costs for the actually utilized processing can be rendered to the customer for billing.

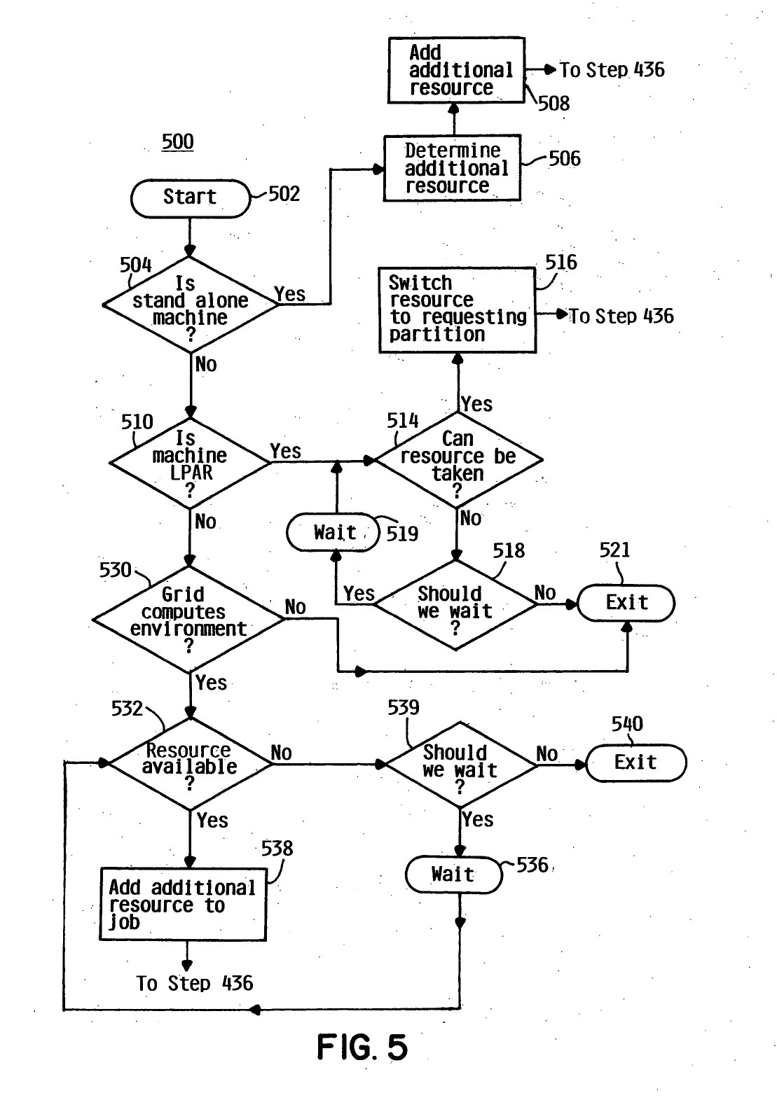

Reference is made to FIG. 5 for illustrating a method 500 for allocating appropriate resources that is to occur in step 430. In operation of the method 500, appropriate resources are added to the current process in order for the batch job to finish at or in close proximity to the predefined batch window. In step 502, the adding resources process starts. In step 504, a determination is made as to whether the processing is being done on a stand-alone or unpartitioned computer system. If No, then step 510 follows. Alternatively, if Yes, then in step 506 an algorithm is applied to determine an add resources value related to the amount of resources (e.g., extra CPU, memory) that should be allocated to reduce the average job step processing time. Preferably, the amount of resources allocated will be appropriate to speed up the batch job, whereby it will be running on predefined schedule by the next time interval at step 416. The data from step 506 is forwarded to step 508 wherein additional resources are to be added to the overall process based thereon. Thereafter, the process proceeds to step 436.

In step 504, if a No determination is decided, then step 510 is performed. In step 510, a determination is made as to whether or not the computer system being used for the batch processing is a logical partitioning (LPAR) computer system. If No, then step 530 follows. Alternatively, if Yes, then step 514 follows. In step 514, a determination is made whether additional resources can currently be allocated in an appropriate amount from the available logical partitions. If Yes, then step 516 is performed in which the partition manager is operated to presently shift such resources from other partitions to the requesting partition. Then, step 436 is performed. On the other hand, if a No determination is made in step 514, then step 518 is performed. In step 518, a determination is made as to whether the process can wait, an appropriate time, for additional resources from other partitions before the current batch run is negatively impacted. The appropriate time would be a threshold value which if exceeded causes interference with the batch job runtime. Therefore, if Yes, then step 519 follows in which the process waits a predetermined period of time below the threshold value before looping back to step 514. If No, then step 521 is performed.

In step 530, a determination is made as to whether or not resources can be obtained from the grid computing environment. If Yes, then step 532 is performed, wherein a determination is made as to whether grid computing resources are currently available. If Yes, then step 538 is performed in which additional resources are added to the batch job in an appropriate amount and type. The data from step 538 is directed to step 536. Alternatively, if the decision in step 532 is No, then step 539 is performed. In step 539, a determination is made as to whether the batch process can wait for a time before grid resources can be added. If there is adequate time for waiting, then step 536 applies a wait for a predetermined time before resubmitting the request to step 539.

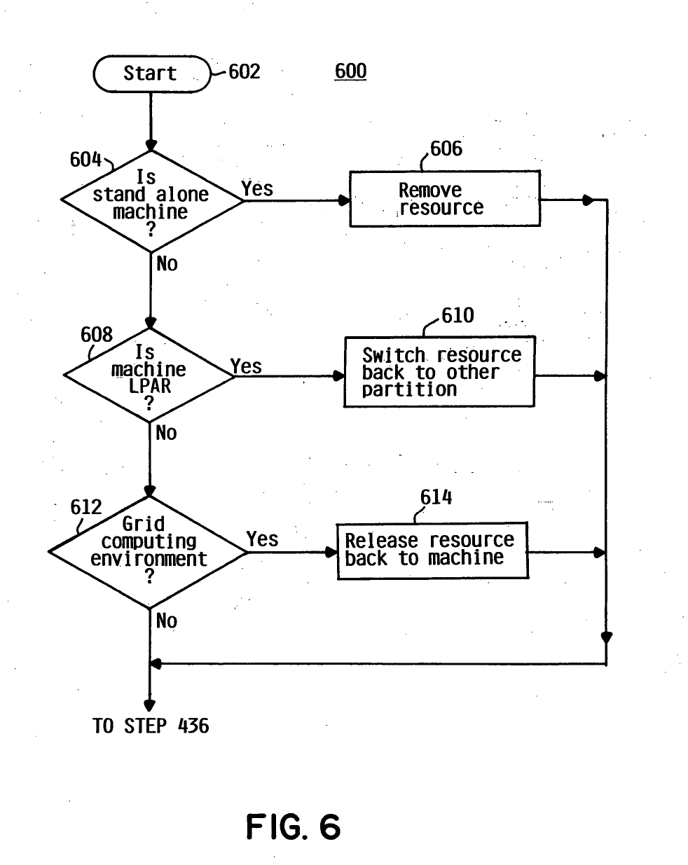

Reference is made to FIG. 6 for illustrating a resource removal method 600 for allocating appropriate resources that is to occur in step 434. In operation of the method 600, appropriate resources are added to the current process in order for the batch job to finish at or in close proximity to the predefined batch window. The resource removal process 600 starts in step 602. In step 604, a determination is made as to whether the processing being performed is on a stand-alone or unpartitioned computer system or not. If Yes, then in step 606 an algorithm is applied to determine the amount of computer resources that can be de-allocated or removed without impacting negatively on the batch job finishing its runtime at or in close proximity to the predefined batch window. Specifically in step 606, it is determined if an appropriate amount of computer resources, such as CPU, may be de-allocated. The data from step 606 is forwarded to step 436, wherein CPU resources are subtracted or de-allocated. Thereafter step 436 follows in which this data can be used to have the batch process return to schedule by at least the next time interval.

Alternatively, if No is determined in step 604, then step 608 is performed in which it is determined if the machine that is running is a logically partitioned computer system. If in step 604, No is determined, step 612 is performed. In step 608, a determination is made whether or not the computer system being used is logically partitioned or not. If No, then step 612 is performed. Alternatively, if Yes is decided in step 608, then step 610 is performed. In step 610, the partition manager 640 is notified as to which appropriate resources can be shifted to other partitions from the partition performing the current batch process. Such shifting is based on appropriate input. If No was determined at step 608, then step 612 is performed. In step 612, a determination is made as to whether the grid computing environment 104 is coupled to the computer system 100. If in step 612, the decision is No, then the process 600 proceeds to step 436. Alternatively, if the decision is Yes, then step 614 is performed in which data regarding the appropriate amount of resources is forwarded to the grid control. The grid control is operative for shifting such resources back to the grid environment 104 from the computer system 100.

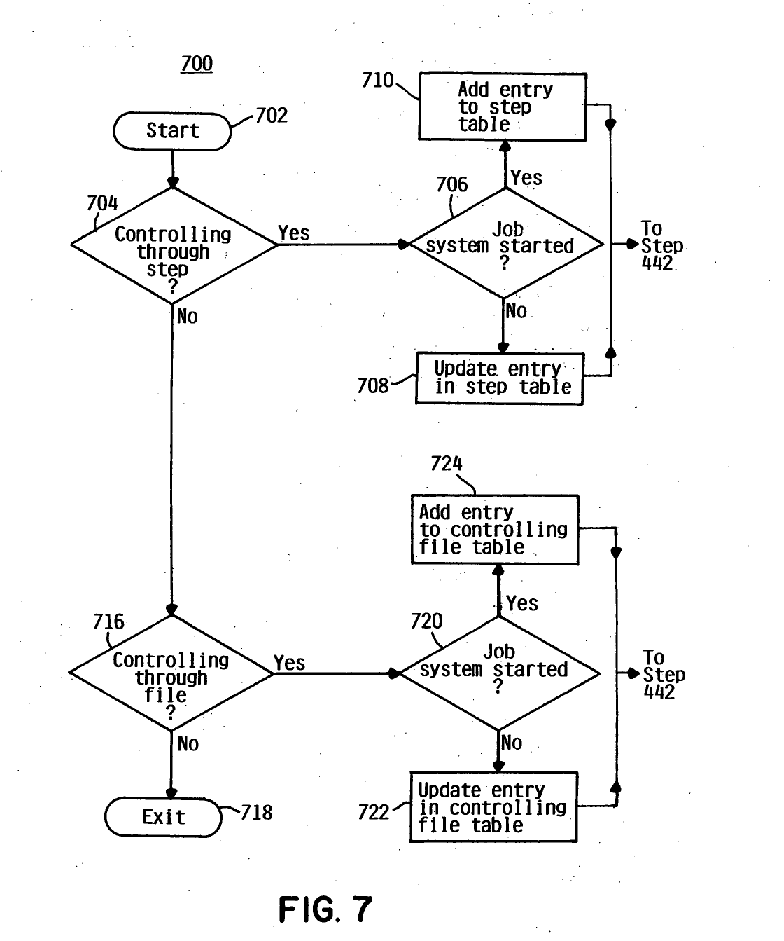

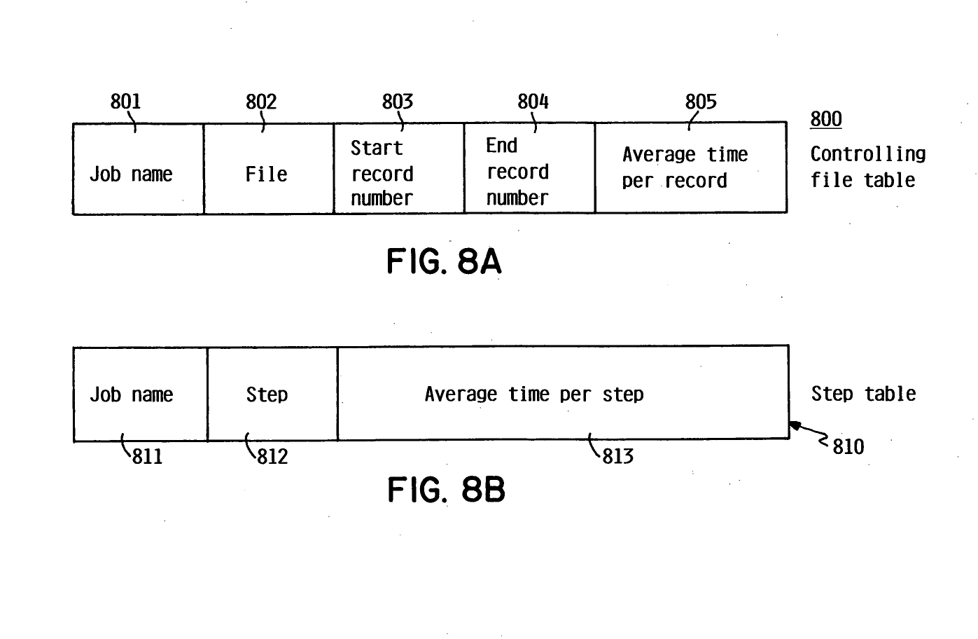

Reference is made back to FIG. 3 and to FIG. 7 for illustrating an historical information updating process 700. The updating is performed by the batch history tool 148. The historical information updating process 700 starts in step 702. In step 704, information is extracted from the batch job as to whether the controlling features are monitored by job steps. If No, then step 716 is performed. Alternatively, if Yes then step 706 is performed. In step 706, a determination is made whether a batch job type (e.g., monthly payroll) is being processed for the first time. If No, then step 708 is performed. In step 708, a job step table 810 (FIG. 8B) has information updated. For example, the inputted information may be in regards to job name 811, current step 812, and average processing time per step 813. The average processing time per step was calculated previously, supra. Alternatively, if the decision at step 706 is Yes, new information is added at step 710 to a new job step entry table (not shown). Following steps 708 and 710, the process proceeds to step 442 (FIG. 4).

In step 716, determination is made as to whether the batch job is being controlled thru a controlling file. If No, then step 718 is performed in which then the process exits. Alternatively, if Yes, controlling is performed through a controlling type of batch file, then step 720 is performed. In step 720 a determination is made as to whether the batch job is being processed for the first time. If No, then in step 722 the information that is gathered is updated in the controlling file update table 800 (FIG. 8A). Information in table 800 includes a job name category 801, a file name category 802, a start record number category 803, an end record number category 804 and an average time per record category 805. Alternatively, if Yes, then in step 724 the information is added to a new controlling file table. Following steps 722 and 724, the process goes to step 442. It will be appreciated that the foregoing steps are exemplary in terms of performing the historical information updating process 700.

In step 442, the actual usage meter module 147 determines the actual usage of resources and types of resources. It takes into account the input demanded by a customer thru parameter values input for configuring operation of the system.

The system users may be charged a fee based on the time it takes to process a request. Different time-based pricing schedules may specify a variety of pricing criteria. In one embodiment, a completion time criterion that defines a maximum acceptable time to complete a request may be specified. If the amount of time needed to perform the request is less than the maximum acceptable time specified, returning the results may be delayed to avoid providing services valued in excess of what the system user has paid for.

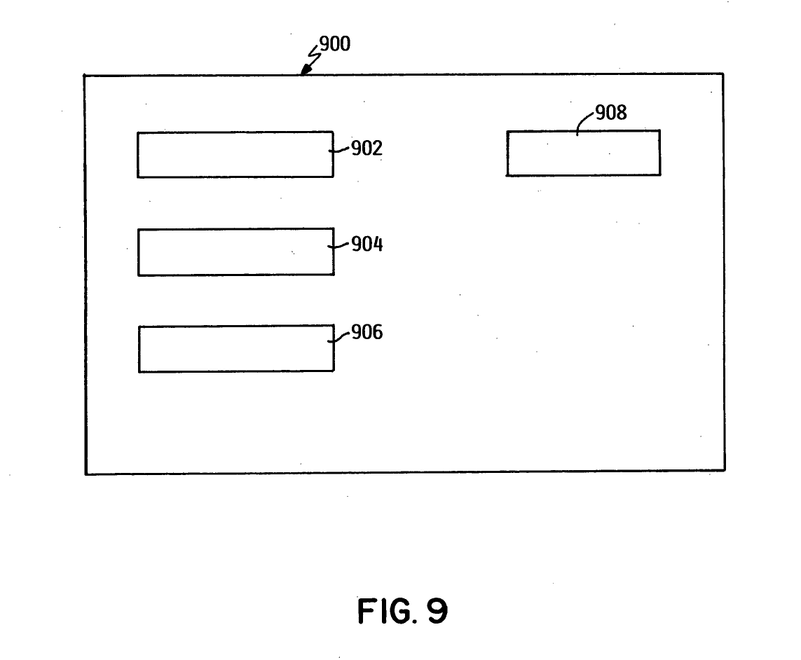

FIG. 9 illustrates a graphical user interface (GUI) configuration screen 900 for allowing a system user to configure parameters that are used in the performance of the steps of the present invention. In this regard, a field 902 is provided in which values are input for parameters controlling predefined batch run time or service time. Field 904 is useful in terms of having the system user identifying controlling files wherein the batch job steps are identified including starting job step and the total amount of job steps in a batch file. Field 906 is used for parameter values regarding processing information pertaining to files, such as well as processes involved. Field 908 is used for having the system user identifying prepayment amount for the resources in order to have a batch job finish in the desired time interval. Other fields can be provided consistent with the teachings of the present invention

While batch processing is preferred, the batch scheduling method of the present invention is applicable to other long-running files or programs. Such long-running programs would have characteristics similar to batch files in that they would be assigned to run without additional computer interaction and the steps or process would be identifiable with a job control language or the like.

At this point, while the present invention has been described in the context of a fully functional computer system, those skilled in the art will appreciate that the present invention is capable of being distributed as a program product. The present invention applies equally as well regardless of the particular type of computer readable signal bearing media used to actually carry out the distribution.

One aspect of the invention is implemented as a program product for use with a computer system or environment. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices generally within a computer such as CD-ROM disks readable by a CD-ROM drive); (ii) alterable information stored on writable storage media (e.g., floppy disks generally within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature utilized is merely for convenience. Thus, the invention should not be limited to use solely in any specific application identified and/or implied by such nomenclature.

The embodiments and examples set forth herein were presented to explain best the present invention and its practical applications, thereby enabling those skilled in the art to make and use the invention. However, those skilled in the art will recognize that the foregoing description and examples have been presented for the purposes of illustration and example only. The description set forth is not intended to be exhaustive or to limit the invention to the precise forms disclosed. In describing the above-preferred embodiments illustrated in the drawings, specific terminology has been used for the sake of clarity. However, the invention is not intended to be limited to the specific terms selected. It is to be understood that each specific term includes all technical equivalents that operate in a similar manner to accomplish a similar purpose. Many modifications and variations are possible in light of the above teachings without departing from the spirit and scope of the appended claims.

1. Apparatus comprising:
one or more processors;
a memory coupled to at least the one processor; and,
a scheduling manager residing in the memory and executable by the at least one processor for enabling periodic monitoring of a program generally within a predefined servicing period; and, dynamically predicting an amount of computer resources needed to complete the program at or in close proximity to the predefined servicing period.

2. Apparatus comprising:
one or more processors;
a memory coupled to at least the one processor; and,
a batch scheduling manager residing in the memory and executable by the at least one processor for enabling periodic monitoring of execution of a batch job generally within a predefined servicing period; and, dynamically predicting an amount of computer resources needed to complete the batch job at or in close proximity to the predefined servicing period.

3. The apparatus recited in claim 2, wherein dynamically predicting is based on monitoring progress of the batch job execution, and evaluating available processing computer resources to determine whether the computer resources should be allocated and/or de-allocated so as to complete processing of the batch job at or in close proximity to the predefined servicing period.

4. The apparatus recited in claim 2 further comprising: the batch scheduling manager dynamically allocates and/or de-allocates computer resources as appropriate.

5. The apparatus recited in claim 2, further comprising: at least one additional resource coupled to the at least one processor for providing an additional computer resource; and, the batch scheduling manager dynamically allocating resources of the additional computer resource for completing execution of the batch job generally within the predefined servicing period.

6. The apparatus recited in claim 2 further comprising: the batch scheduling manager enabling one or more indications that the batch job will not be executed generally within the predefined servicing period.

7. The apparatus recited in claim 2 further comprising: the batch scheduling manager rendering costs for computer resources actually utilized generally within the predefined servicing period.

8. The apparatus recited in claim 7 further comprising: the batch scheduling manager rendering costs includes rendering of costs associated with any additional computer resources that was provided to the batch job processing.

9. The apparatus recited in claim 5 wherein the at least one resource that is dynamically enabled is provided by a networked computing grid.

10. The apparatus recited in claim 6 wherein the at least one resource that is dynamically enabled is provided by additional processor partitions of the at least one processor.

11. The apparatus recited in claim 2 wherein a user interface coupled to the system allows a user to configure parameter values of one or more additional resources that are available to be utilized.

12. The apparatus recited in claim 2 wherein a user interface coupled to the at least one processor allows a user to establish parameter values for type or class of processing.

13. A computer-implemented method in a system having at least one processor; a memory coupled to the at least one processor, and a scheduling manager residing in the memory and being executable for: enabling periodic monitoring of progress of executed portions of a program generally within a predefined servicing period; and, dynamically predicting computer resources needed to complete a program generally within the predefined servicing period.

14. A computer-implemented batch method in a system having at least one processor; a memory coupled to the at least one processor, and a batch scheduling manager residing in the memory and being executable, the method comprising the steps of: enabling periodic monitoring of progress of executed portions of a batch job generally within a predefined servicing period; and, dynamically predicting computer resources needed to complete a batch job generally within the predefined servicing period.

15. The method recited in claim 14 further comprising dynamically allocating one or more computer resources needed for completing the batch job generally within the predefined servicing period in response to dynamic predictions.

16. The method recited claim 15 further comprising rendering of costs for computer resources actually utilized in completing the batch job.

17. The method recited in claim 15 wherein the dynamic predictions are determined by at least evaluating the initial size of a batch job, periodic monitoring of progress of the amount of executed portions of a batch job, and evaluating available processing computer resources.

18. The method recited in claim 15 further comprising providing at least one additional resource coupled to the at least one processor; and, the batch scheduling manager dynamically allocating resources of the additional resource for completing execution of the batch job generally within the predefined servicing period.

19. A computer-implemented batch method in a processor system having at least one processor; a memory coupled to the at least one processor, and a batch scheduling manager residing in the memory, the method comprising: having the scheduling manager being executable for: enabling monitoring of the progress of execution of a batch job in each one of a plurality of time segments to be monitored generally within a predefined servicing period of the batch job; and, dynamically predicting computer resources needed to complete the batch job generally within the predefined servicing period.

20. The method recited in claim 19 further comprising: dynamically enabling allocation of computer resources to the processing of the batch job on the basis of predictive computer resources to be utilized to complete the batch job processing.

21. The method recited in claim 19 further comprising rendering costs for computer resources actually utilized during processing of the batch job.

22. The method recited in claim 19 wherein the enabled resource is additional computer resources.

23. The method recited in claim 19 wherein the enabled resource is additional memory capacity.

24. The method recited in claim 19 wherein obtaining additional resources from is from a networked computing grid.

25. The method recited in claim 19 wherein obtaining additional resources from is from additional processor partitions of the at least one processor.

26. The method recited in claim 19 further comprising utilizing a user interface coupled to the system to allow a user to establish parameter values for the servicing period.

27. The method recited in claim 19 further comprising utilizing a user interface coupled to the at least one processor to allow a user to establish parameter values for costs of processing.

28. A method of dynamically allocating computer resources for executing a batch job during a predefined servicing period, comprising the steps of:
providing a processing system for one or more users, wherein the system includes at least one resource providing variable computer resources;
establishing a plurality of time segments to be monitored generally within the predefined servicing period that is allocated for execution of the batch job, enabling monitoring of progress of execution of a batch job portion in each of the time segments; and, predicting if the batch job will execute generally within the predefined servicing period based on monitoring of the progress of those portions of the batch job already executed in each of the time segments and the amount of computer resources of the processing system.

29. The method recited in claim 28 further comprising dynamically enabling allocation of additional computer resources to the processing of the batch job on the basis of the estimate indicating the amount of additional computer resources to be utilized to complete the batch job processing generally within the predefined batch memory.

30. The method recited in claim 28 further comprising having the batch scheduling manager rendering costs for additional computer resources actually utilized during processing of the batch job.

31. The method recited in claim 29 further wherein the rendering of costs includes rendering costs associated with any additional computer resources that was provided to the batch job processing.

32. The method recited in claim 29 further comprising providing one or more user interfaces to allow configurations for allowing a user to establish parameter values for the servicing period.

33. The method recited in claim 29 further comprising providing one or more user interfaces to allow configurations for allowing a user to establish parameter values for costs of processing.

34. The method recited in claim 29 wherein the at least one dynamically enabled resource is provided by a networked computing grid.

35. The method recited in claim 29 wherein the at least one dynamically enabled resource is provided by additional processor partitions of the at least one processor.

36. A program product comprising: a batch scheduling manager that manages dynamic allocation of at least one resource in a processing system that provides additional computer resources to a batch job process; the program product comprising: a medium readable by a computer and having a computer program product comprising a batch scheduling manager resides that resides in memory and is executable by the at least the one processor so as to dynamically predict the amount of computer resources needed to complete the batch job at or in close proximity to the predefined servicing period.

37. The program product of claim 36 wherein the batch scheduling manager dynamically allocates and/or de-allocates computer resources.

38. The program product of claim 37 wherein the batch scheduling manager apportions costs for actually utilized computer resources.

39. A networked environment, comprising:
a grid of computing resources;
a request manager of the grid to receive requests of one or more customers for utilization of computing resources of the grid;
one or more computer systems of a customer coupled to the request manager; the one computer system comprising one or more processors;
a memory coupled to at least the one processor of the one computer system;
a scheduling manager residing in the memory and executable by the at least one processor for enabling periodic monitoring of execution of a batch job generally within a predefined servicing period; and, dynamically predicting an amount of computer resources needed to complete the batch job at or in close proximity to the predefined servicing period; the batch scheduling manager communicating with the request manager for enabling dynamically allocating and/or de-allocating computer resources as appropriate from the grid.

40. A computer-implemented method for use in a networked environment including a grid of computing resources, and a request manager of the grid to receive requests of one or more customers for utilization of computing resources of the grid; wherein one or more computer systems of a customer is coupled to the request manager and include one or more processors; a memory coupled to at least the one processor; and, a scheduling manager residing in the memory and executable by the at least the one processor, comprising the steps of: a scheduling manager residing in the memory and executable by the at least one processor for enabling periodic monitoring of execution of a batch job generally within a predefined servicing period; and, dynamically predicting the amount of computer resources needed to complete the batch job at or in close proximity to the predefined servicing period; the batch scheduling manager communicating with the request manager for enabling dynamically allocating and/or de-allocating computer resources as appropriate from the grid.

41. A method of providing fee-based processing for batch jobs in a processor system, whereby fees are based on actual utilization of computer resources in accordance with user configured parameters for completing processing of a batch job at or in close proximity to a predefined servicing period of a batch process; the processor system including at least one processor; a memory coupled to the at least one processor, and a batch scheduling manager residing in the memory, the method comprising having the scheduling manager being executable for: enabling monitoring of a progress of execution of the batch job in each one of a plurality of time segments to be monitored generally within the predefined servicing period of the batch job; dynamically predicting an amount of computer resources needed to complete the batch job generally at or in close proximity to the predefined servicing period; dynamically allocating computer resources for processing the batch job based on the predicted amount of needed computer resources; and, metering actual utilization of the needed computer resources for rendering fees for processing the batch job.

42. A method of providing fee-based dynamic allocation of computer resources for executing a batch job during a predefined servicing period, comprising the steps of:
providing a processing system for one or more users, wherein the system includes at least one resource providing variable computer resources; and,
establishing a plurality of time segments to be monitored generally within the predefined servicing period that is allocated for execution of the batch job, enabling monitoring of progress of execution of a batch job portion in each of the time segments; and, predicting if the batch job will execute generally within the predefined servicing period based on monitoring of progress of those portions of the batch job already executed in each of the time segments and an amount of computer resources of the processing system needed to complete the batch job within the predefined servicing period; and, metering actual utilization of the needed computer resources for rendering fees for processing the batch job.

43. A computer program product for use in a computer-implemented process for providing fee-based dynamic allocations of computer resources for executing a batch job at or reasonably close to a predefined batch servicing period, the computer program product comprising: a medium readable by a computer and having computer program code adapted for: providing a batch scheduling manager that manages dynamic allocation of at least one processor in the computer-implemented process that provides additional computer resources to a batch job process; wherein the batch scheduling manager resides in memory and is executable by the at least one processor so as to dynamically predict an amount of computer resources needed to complete the batch job at or in close proximity to the predefined servicing period; dynamically allocating computer resources in order to complete the batch job within the predefined servicing period, and, metering actual utilization of the needed computer resources for rendering fees for processing the batch job.
